(19) United States
(12) Patent Application Publication
(10) Pub. No.: US 2019/0154927 A1
(43) Pub. Date: May 23, 2019

(54) METHOD FOR MANUFACTURING OPTICAL CONNECTOR

(71) Applicant: SUMITOMO ELECTRIC INDUSTRIES, LTD., Osaka-shi, Osaka (JP)

(72) Inventors: Osamu SHIMAKAWA, Yokohama-shi, Kanagawa (JP); Sho YAKABE, Yokohama-shi, Kanagawa (JP); Takuro WATANABE, Yokohama-shi, Kanagawa (JP)

(73) Assignee: SUMITOMO ELECTRIC INDUSTRIES, LTD., Osaka-shi, Osaka (JP)

(21) Appl. No.: 16/313,212

(22) PCT Filed: Jun. 12, 2017
(86) PCT No.: PCT/JP2017/021659

§ 371 Date: Dec. 26, 2018

(30) Foreign Application Priority Data
Aug. 26, 2016 (JP) 2016-166105

(51) Int. Cl. G02B 6/38

(52) U.S. Cl. CPC G02B 6/3847; G02B 6/3861; G02B 6/3863

(57) ABSTRACT

A method for manufacturing an optical connector according to one embodiment is a method for manufacturing an optical connector having a ferrule including an end face at which an optical fiber holding hole for holding an optical fiber is opened, the method including: a step of inserting the optical fiber into the optical fiber holding hole and fixing the optical fiber to expose the optical fiber at the end face; a step of polishing the end face together with the optical fiber; and a step of heating another region excluding a region where the optical fiber is exposed at the end face to make the other region higher than the region where the optical fiber is exposed.

### TECHNICAL FIELD

One aspect of the present invention relates to a method for manufacturing an optical connector.

This application claims priority based on Japanese Patent Application No. 2016-166105 filed on Aug. 26, 2016 and incorporates all the contents described in the Japanese application.

### BACKGROUND ART

Non-Patent Literature 1 discloses a ferrule used for an optical connector which connects multicore optical fibers to each other. This ferrule has a plurality of holes for holding each of a plurality of the optical fibers, and a guide hole into which a positioning guide pin is inserted. By inserting the guide pin into this guide hole, the ferrule is precisely positioned.

### CITATION LIST

### Non Patent Literature

Non Patent Literature 1: S. Nagasawa et al., “A high-performance single-mode multifiber connector using oblique and direct endface contact between multiple fibers arranged in a plastic ferrule, “IEEE Photonics Technology Letters, vol. 3, no. 10, pp. 937-939(1991)

### SUMMARY OF INVENTION

A method for manufacturing an optical connector according to the present disclosure is a method for manufacturing an optical connector having a ferrule including an end face at which an optical fiber holding hole for holding an optical fiber is opened, the method including: a step of inserting the optical fiber into the optical fiber holding hole and fixing the optical fiber to expose the optical fiber at the end face; a step of polishing the end face together with the optical fiber; and a step of heating another region excluding a region where the optical fiber is exposed at the end face to make the other region higher than the region where the optical fiber is exposed.

### BRIEF DESCRIPTION OF DRAWINGS

FIG. 1 is a perspective view showing an optical connector according to a first embodiment.

FIG. 2 is a perspective view showing the connection between the optical connector in FIG. 1 and a mating connector.

FIG. 3 is a sectional side view showing the ferrule of the optical connector in FIG. 1.

FIG. 4 is a perspective view showing a method for manufacturing the optical connector in FIG. 1.

FIG. 5 is a side view showing the method for manufacturing the optical connector in FIG. 1.

FIG. 6A is a front view showing a modification example of the protrusion portion.

FIG. 6B is a front view showing a modification example of the protrusion portion.

FIG. 6C is a front view showing a modification example of the protrusion portion.

FIG. 6D is a front view showing a modification example of the protrusion portion.

FIG. 7A is a front view showing a modification example of the protrusion portion.

FIG. 7B is a front view showing a modification example of the protrusion portion.

FIG. 7C is a front view showing a modification example of the protrusion portion.

FIG. 8A is a front view showing a modification example of the protrusion portion.

FIG. 8B is a sectional side view showing the connection between the optical connectors in FIG. 8A to each other.

FIG. 8C is a front view showing a modification example of the protrusion portion.

FIG. 9A is a sectional side view showing a modification example of the protrusion portion.

FIG. 9B is a sectional side view showing a modification example of the protrusion portion.

FIG. 10 is a perspective view showing a method for manufacturing an optical connector according to a second embodiment.

FIG. 11 is a front view showing a method for manufacturing an optical connector according to a third embodiment.

FIG. 12 is a sectional side view showing a modification example of the optical connector.

FIG. 13A is a sectional side view schematically showing a conventional optical connection structure.

FIG. 13B is a sectional side view schematically showing a conventional optical connection structure.

### DESCRIPTION OF EMBODIMENTS

### Problems to be Solved by Present Disclosure

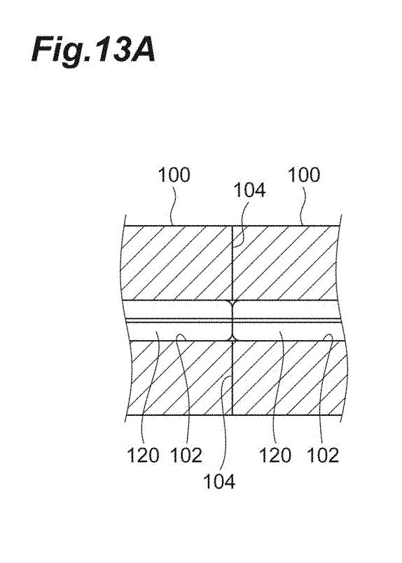

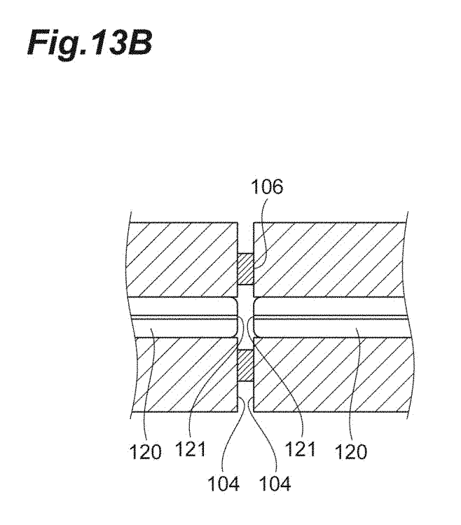

In general, a physical contact (PC) type is known as a type of connecting connectors of optical fibers to each other. FIG. 13A is a sectional side view showing one example of a structure of a PC type ferrule. A ferrule 100 has a hole 102 which holds an optical fiber 120. The optical fiber 120 is inserted through the hole 102. In this PC type, the tip face of the optical fiber 120 is physically brought into contact with the tip face of the optical fiber 120 of a mating connector and pressed, thereby optically coupling the optical fibers 120 to each other.

However, the aforementioned type has the following problems. In the ferrule 100, since the tip faces of the two optical fibers 120 are physically brought into contact or separated to be attached or detached, there is a concern that the tip faces of the optical fibers 120 may be worn if the attachment and detachment are repeated. Moreover, when the connection is performed while dust is on end faces 104 of the ferrules 100, the dust adheres to the end faces 104 due to the pressing force. It is necessary to use a contact type cleaner in order to remove the adhered dust. Furthermore, it is necessary to frequently perform cleaning in order to prevent the adhesion of dust. Further, in a case of a multi-hole ferrule which simultaneously connects a plurality of optical fibers 120, since a predetermined pressing force is required for each one of the optical fibers 120, a greater force is necessary for the connection as the number of optical fibers 120 increases.

For the above problems, for example, as shown in FIG. 13B, a structure, in which spacers 106 are interposed between two end faces 104 to provide a gap between tip faces 121 of two optical fibers 120, can be considered. However, in the structure in which the gap is provided between the tip faces 121, it is necessary to highly accurately adjust the gap since the optical coupling state may be changed depending on the length of the gap. Moreover, it is necessary to highly accurately design the thickness of the spacers 106 since the spacers 106 define the gap. Furthermore, it is required to make the thickness of the spacers 106 very thin since the gap is very small. Therefore, it is difficult to design and manufacture the spacers 106, which leads to high costs, and the spacers 106 may fall off so that it is difficult to handle the spacers 106 under conventional design.

The present disclosure has been made in light of such problems, and an object thereof is to provide a method for manufacturing an optical connector, which can manufacture an optical connector that can be easily designed and manufactured and has good handleability.

### Effects of Present Disclosure

According to the present disclosure, it is possible to manufacture an optical connector that can be easily designed and manufactured and has good handleability.

### DESCRIPTION OF EMBODIMENTS OF PRESENT INVENTION

First, the contents of the embodiments of the present invention will be listed and described.

A method for manufacturing an optical connector according to one embodiment of the present invention is a method for manufacturing an optical connector having a ferrule including an end face at which an optical fiber holding hole for holding an optical fiber is opened, the method including: a step of inserting the optical fiber into the optical fiber holding hole and fixing the optical fiber to expose the optical fiber at the end face; a step of polishing the end face together with the optical fiber; and a step of heating another region excluding a region where the optical fiber is exposed at the end face to make the other region higher than the region where the optical fiber is exposed.

In this method for manufacturing the optical connector, the other region excluding the region where the optical fiber is exposed at the end face is made higher than the region where the optical fiber is exposed. Thus, the region where the optical fiber is exposed at the end face becomes a region recessed from the other region. Therefore, since the tip face of the optical fiber does not make contact with the other fibers while connection, the tip face of the optical fiber does not wear out even though the mating and unmating are repeated. Moreover, since the region where the optical fiber is exposed at the end face is a region which does not physically make contact, even if dust enters this region, the adhesion of the dust can be avoided. Therefore, cleaning for removing foreign matter can be easily performed. Furthermore, by heating and making higher the other region excluding the region where the optical fiber is exposed, the aforementioned spacers can be made unnecessary, and a gap can be easily formed between the tip faces of the optical fibers. Since the spacers can be made unnecessary in this way, it is possible to manufacture an optical connector that can be easily designed and manufactured at low costs and has good handleability.

In the aforementioned method for manufacturing the optical connector, the other region may be irradiated with a laser beam to heat the other region in the step of making the other region higher. In this case, by performing the irradiation with the laser beam, the other region can be heated in a non-contact manner. This makes it possible to easily heat the other region as compared with a case where a heating member is brought into contact with the other region to heat the other region. Further, for example, by using a mask to perform the irradiation with the laser beam, a complicated shape can be easily formed.

Moreover, in the step of making the other region higher, the other region may be heated so that the height of the other region with respect to the region where the optical fiber is exposed becomes 5 μm or more and 200 μm or less. In this case, the gap between the tip face of the optical fiber and the tip face of the optical fiber of the mating connector can be set to 5 μm or more and 200 μm or less. Therefore, even with a configuration without a lens, shortening the distance between the two tip faces allows the connection between these optical fibers with low coupling loss.

Furthermore, in the step of making the other region higher, the other region may be heated so that the ratio of the area of the other region to the total area of the end face becomes 5% or more and 60% or less. Since the ratio of the area of the other region to the total area of the end face is 60% or less, it is possible to prevent the heating time from becoming longer. Further, since the ratio of the area of the other region to the total area of the end face is 5% or more, the pressure acting on the other region can be reduced when the other region is pressed against the mating connector. Thus, it is possible to prevent the wear in the other regions due to the pressure.

### DETAILS OF EMBODIMENTS OF PRESENT INVENTION

Specific examples of a method for manufacturing an optical connector according to the embodiments of the present invention will be described below with reference to the drawings. Note that the present invention is not limited to the following examples, but is indicated by the scope of the claims, and intended to include meanings equivalent to the scope of the claims and all changes within the scope. In the following description, the same or corresponding elements are denoted by the same reference signs in the description of the drawings, and redundant descriptions are omitted.

### First Embodiment

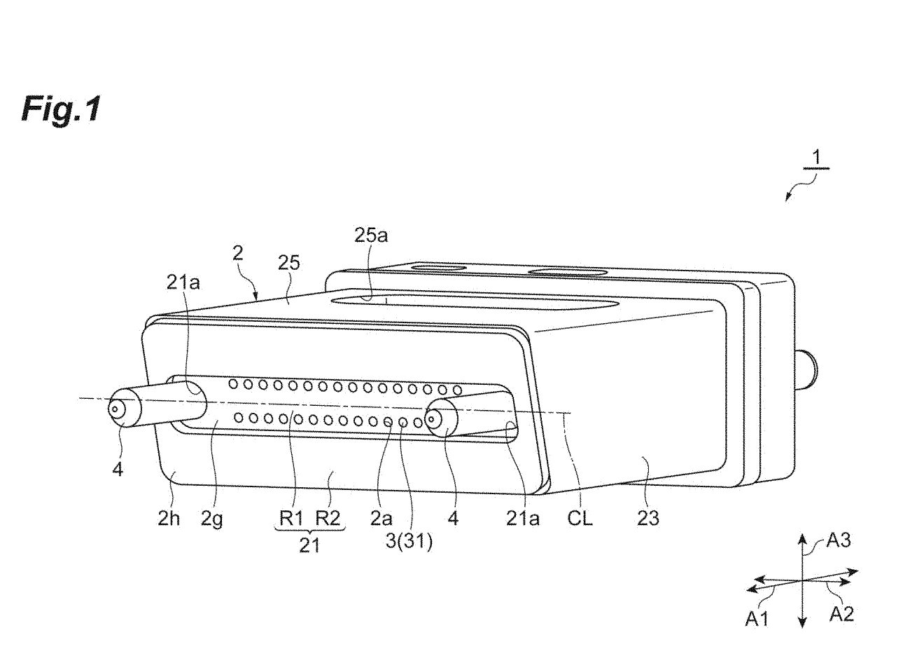

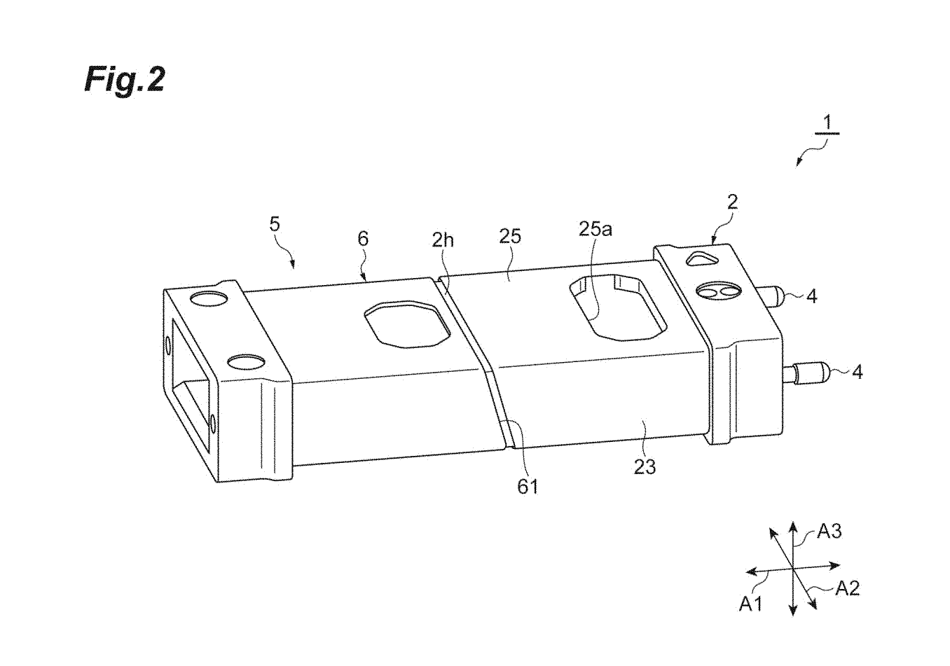

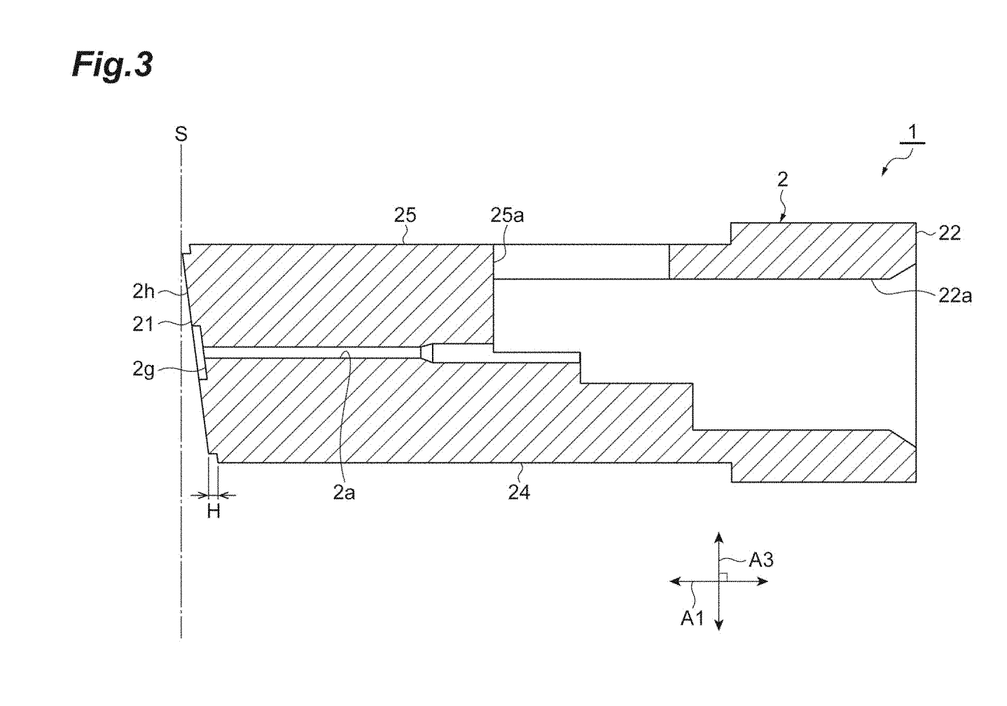

First, a method for manufacturing an optical connector 1 according to a first embodiment will be described. FIG. 1 is a perspective view showing the optical connector 1. FIG. 2 is a perspective view showing the connection between the optical connector 1 and a mating connector 5. FIG. 3 is a sectional side view showing a ferrule 2 of the optical connector 1. The optical connector 1 includes the ferrule 2 and an optical fiber 3. The ferrule 2 exhibits an approximately rectangular parallelepiped appearance. The ferrule 2 is made of, for example, a resin such as polyphenylene sulfide (PPS) with glass filler.

For example, the optical connector 1 is connected in a connection direction A1 to the mating connector 5 having a configuration similar to that of the optical connector 1. At least one of the optical connector 1 and the mating connector 5 has a built-in spring that presses the optical connector 1 and the mating connector 5 in a direction to connect each other. The ferrule 2 has an end face 21 which is provided on one end side of the connection direction A1 and faces the mating connector 5, a rear end face 22 provided on the other end side of the connection direction A1, a pair of side faces 23 extending in the connection direction A1, a bottom face 24 and an upper face 25. Note that the mating connector 5 includes, for example, a ferrule 6 configured similarly to the ferrule 2. The ferrule 6 includes an end face 61. The end face 61 is configured similarly to the end face 21 and faces the end face 21.

The end face 21 has a region R1 where the optical fiber 3 is exposed, and another region R2 excluding the region R1. For example, the region R1 is formed in a horizontally elongated rectangular shape at the end face 21, and the four corners of the region R1 are rounded. In the region R1, a tip face 31 of the optical fiber 3 is exposed.

For example, the region R2 is formed in a rectangular frame shape surrounding the region R1 at the end face 21. The region R2 is formed higher than the region R1. In the region R2, a protrusion portion 2h protruding from the region R1 is provided. For example, the protrusion portion 2h protrudes in a rectangular shape from the region R1. The top face of the protrusion portion 2h is in contact with the end face 61 facing the end face 21. The region R1 is located in a recess portion 2g recessed from the protrusion portion 2h. A height H of the protrusion portion 2h with respect to the recess portion 2g is, for example, 5 μm or more and 200 μm or less. The ratio of the area of the region R2 to the total area of the end face 21 is, for example, 5% or more and 60% or less.

A pair of guide holes 21a is formed in the region R1 at the end face 21. Into each of the guide holes 21a, each of guide pins 4 for positioning the optical connector 1 and the mating connector 5 is inserted. The pair of guide holes 21a is arranged along a direction A2 intersecting with the connection direction A1. For example, the direction A2 is a direction which is orthogonal to the connection direction A1, is the longitudinal direction of the end face 21 and is a direction orthogonal to the side faces 23. The pair of guide holes 21a is arranged on both end sides of the tip face 31 of the optical fiber 3 in the direction A2. The pair of guide pins 4 protrudes from the recess portion 2g in the connection direction A1.

A hole portion 25a is formed at the upper face 25, and the optical fiber 3 inside the ferrule 2 can be visually recognized from the hole portion 25a. The hole portion 25a exhibits, for example, an octagonal shape in planar view. The hole portion 25a is an introduction hole for an adhesive. Thus, the optical fiber 3 is bonded and fixed inside the ferrule 2 by introducing the adhesive into the inside of the ferrule 2 from the hole portion 25a in a state where the optical fiber 3 is arranged inside the ferrule 2.

At the rear end face 22 of the ferrule 2, an introduction hole 22a for collectively receiving the plurality of optical fibers 3 is formed. The plurality of optical fibers 3 are introduced in with, for example, 0.25 mm jacket, 0.9 mm jacket, ribbon optical fiber or the like. The ferrule 2 includes a plurality of optical fiber holding holes 2a, and each of the plurality of optical fibers 3 is inserted into each optical fiber holding hole 2a. The optical fiber 3 is, for example, a single mode fiber. Each of the plurality of optical fiber holding holes 2a penetrates from the introduction hole 22a to the end face 21.

Each optical fiber holding hole 2a penetrates in the connection direction A1. Both of the central axis direction of each optical fiber holding hole 2a and the optical axis direction of the optical fiber 3 coincide with the connection direction A1. The tip faces 31 of the plurality of optical fibers 3 are aligned along the direction A2 at the end face 21. A set of the plurality of tip faces 31 aligned in a line is aligned in two stages in a direction A3 intersecting with the direction A2. The direction A3 is, for example, a direction orthogonal to the upper face 25. The connection direction A1, the direction A2 and the direction A3 are, for example, orthogonal to each other.

The tip face 31 of each optical fiber 3 is, for example, flush with the bottom face of the recess portion 2g. In the cross section along the optical axis of the optical fiber 3, the normal direction of the tip face 31 of the optical fiber 3 is inclined with respect to the central axis direction of the optical fiber holding hole 2a, that is, the optical axis direction of the optical fiber 3. This inclination angle coincides with the inclination angle with respect to a plane S orthogonal to the optical axis of the optical fiber 3, and the value of this inclination angle is, for example, 8° or more and 20° or less.

In the region R1, for example, the tip faces 31 of the plurality of optical fibers 3 are arranged at equal intervals, and 16 tip faces 31 are arranged along the direction A2. As for a set of 16 tip faces 31 arranged along the direction A2, two sets are arranged along the direction A3, and, for example, a total of 32 tip faces 31 are arranged. The sets of 16 tip faces 31 are arranged at positions shifted upward and downward from a central axis line CL passing through the center of the end face 21 and extending in the direction A2. The plurality of tip faces 31 are arranged at positions symmetric to each other about the central axis line CL.

A method for manufacturing the optical connector 1 configured as described above will be described. Hereinafter, a method for manufacturing the optical connector 1 having the ferrule 2 including the end face 21 at which the optical fiber holding hole 2a for holding the aforementioned optical fiber 3 is opened will be described.

First, each of the plurality of optical fibers 3 is inserted into each optical fiber holding hole 2a from the introduction hole 22a at the rear end face 22 of the ferrule 2, and the plurality of optical fibers 3 are protruded from the end face 21. At this time, the optical fiber 3 is inserted into the optical fiber holding hole 2a to expose the optical fiber 3 at the end face 21, and an adhesive is introduced into the hole portion 25a of the ferrule 2 to bond and fix the optical fiber 3 to the ferrule 2 (step of exposing the optical fiber at the end face). Then, a portion of the optical fiber 3, which is protruding from the end face 21, is cut off, and the end face 21 is polished together with the optical fiber 3 (step of polishing the end face together with the optical fiber).

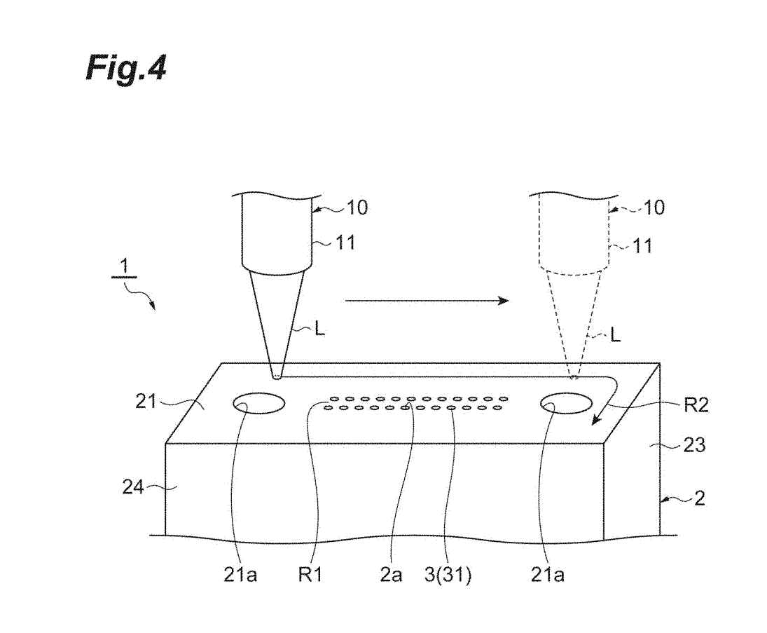

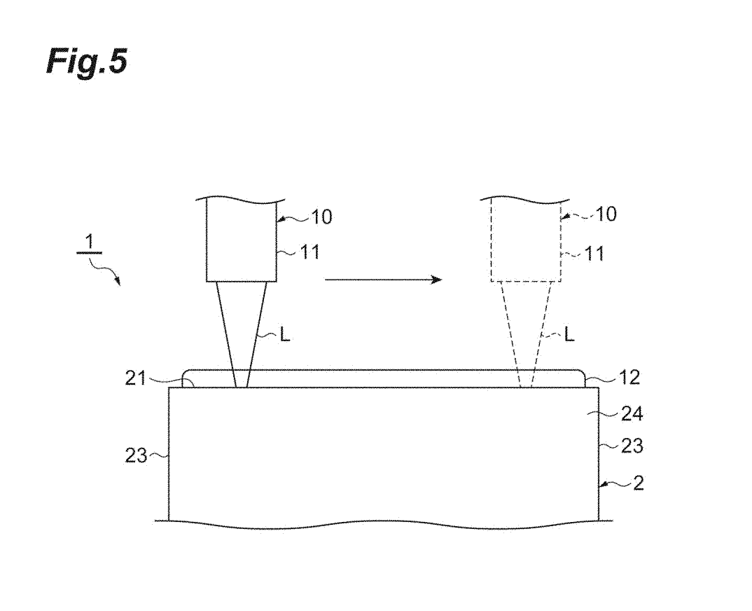

After the end face 21 is polished together with the optical fiber 3, for example, as shown in FIGS. 4 and 5, the end face 21 of the ferrule 2 is directed upward. Then, on the end face 21, an elastic plate 12 made of a material which transmits a laser beam L is uniformly placed. The elastic plate 12 is, for example, silicone rubber, and the thickness of it is about 2 mm. Note that the illustration of the elastic plate 12 is omitted in FIG. 4 to simplify the illustration.

Next, by using a laser apparatus 10, the region R2 is irradiated with the laser beam L to heat the region R2. The laser apparatus 10 includes a laser head 11. The laser head 11 performs the irradiation with the laser beam L which is, for example, a spot beam whose beam diameter is reduced to 1 mm or less. For example, the wavelength of the laser beam L is 940 nm or 1070 nm, and the laser beam L is a semiconductor laser. At this time, while the laser head 11 is moved along the end face 21, a portion where the protrusion portion 2h is to be formed is irradiated with the laser beam L to heat this portion. By heating in this manner, the region R2 is expanded to fowl the protrusion portion 2h.

At this time, for example, the region R2 is heated so that the height H of the protrusion portion 2h becomes 5 μm or more and 200 μm or less. The height H of the protrusion portion 2h is controlled by at least one of the irradiation power and the irradiation time of the laser beam L. That is, it is possible to increase the height H by increasing the irradiation power of the laser beam L or elongating the irradiation time with the laser beam L. For example, the protrusion portion 2h may be formed by performing the irradiation with the laser beam L with high irradiation power once, or the protrusion portion 2h may be formed by performing the irradiation with the laser beam L with low irradiation power a plurality of times. Moreover, the region R2 is heated so that the ratio of the area of the region R2 to the total area of the end face 21 becomes 5% or more and 60% or less.

As previously mentioned, by performing the irradiation with the laser beam L through the elastic plate 12, the elastic plate 12 presses the bulge of the heated region R2. Thus, compared with a case where the elastic plate 12 is not arranged, the flatness of the top face of the protrusion portion 2h can be more reliably secured. Furthermore, in a case where the elastic plate 12 is placed on the end face 21 to perform the irradiation with the laser beam L, it becomes easy to control the height of the protrusion portion 2h, for example, by performing the irradiation with the laser beam L a plurality of times so that the desired height H of the protrusion portion 2h can be more reliably obtained. Further, by using silicone rubber as the elastic plate 12, the adhesion between the end face 21 and the elastic plate 12 can be avoided, and the elastic plate 12 can be easily detached from the end face 21.

As described above, the region R2 on the end face 21 of the ferrule 2 is heated to make the region R2 higher than the region R1 (step of making the other region higher). Then, the region R2 expanded by heating is cooled and cured, thereby forming the protrusion portion 2h. After the protrusion portion 2h is formed, the elastic plate 12 is detached from the end face 21 to complete the manufacture of the optical connector 1.

Next, the effects obtained by the method for manufacturing the optical connector 1 will be described.

In the method for manufacturing the optical connector 1, the other region R2 excluding the region R1 where the optical fiber 3 is exposed at the end face 21 is made higher than the region R1 where the optical fiber 3 is exposed. Thus, the region R1 where the optical fiber 3 is exposed at the end face 21 becomes a region recessed from the region R2. Therefore, since the tip face 31 of the optical fiber 3 does not make contact with the other fibers while connection, the tip face 31 of the optical fiber 3 does not wear out even though mating and unmating are repeated. Moreover, since the region R1 where the optical fiber 3 is exposed at the end face 21 is a region which does not physically contact, even if dust enters this region R1, the adhesion of the dust can be avoided. Therefore, cleaning for removing dust can be easily performed.

Furthermore, by heating and making higher the other region R2 excluding the region R1 where the optical fiber 3 is exposed, the aforementioned spacers can be made unnecessary, and a gap can be easily formed between the tip faces of the optical fibers 3. Since the spacers can be made unnecessary in this way, it is possible to manufacture the optical connector 1 that can be easily designed and manufactured at low costs and has good handleability.

Further, in the step of making the other region R2 higher, the other region R2 is irradiated with the laser beam L to heat the other region R2. Thus, by performing the irradiation with the laser beam L, the other region R2 can be heated in a non-contact manner. This makes it possible to easily heat the other region R2 as compared with a case where a heating member is brought into contact with the other region R2 to heat the other region R2.

Moreover, in the step of making the other region R2 higher, the other region R2 is heated so that the height H of the other region R2 with respect to the region R1 where the optical fiber 3 is exposed becomes 5 μm or more and 200 μm or less. Thus, the gap between the tip face 31 of the optical fiber 3 and the tip face of the optical fiber of the mating connector 5 can be set to 5 μm or more and 200 μm or less. Therefore, even with a configuration without a lens, shortening the distance between the two tip faces allows the connection between these optical fibers with low coupling loss.

Furthermore, in the step of making the other region R2 higher, the other region R2 may be heated so that the ratio of the area of the other region R2 to the total area of the end face 21 becomes 5% or more and 60% or less. Since the ratio of the area of the other region R2 to the total area of the end face 21 is 60% or less, it is possible to prevent the heating time from becoming longer. Further, since the ratio of the area of the other region R2 to the total area of the end face 21 is 5% or more, the pressure acting on the other region R2 can be reduced when the other region R2 is pressed against the mating connector 5. Therefore, it is possible to prevent the wear in the other region R2 due to the pressure.

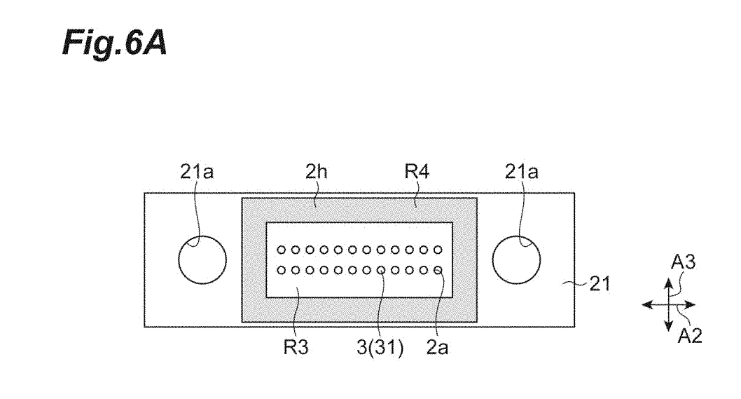

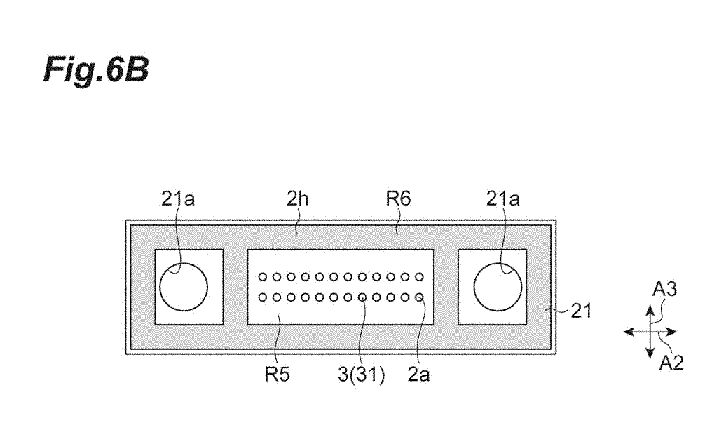

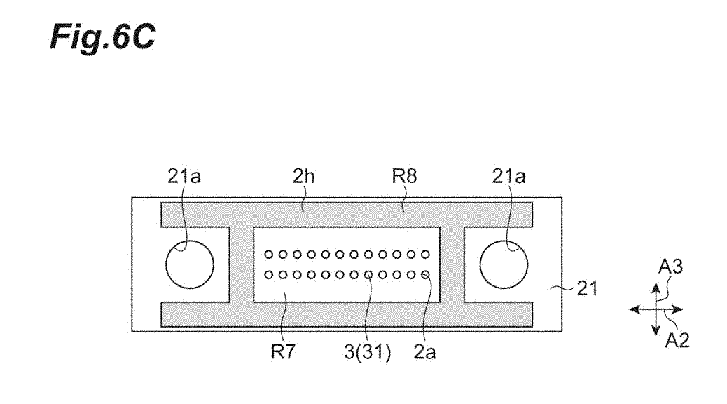

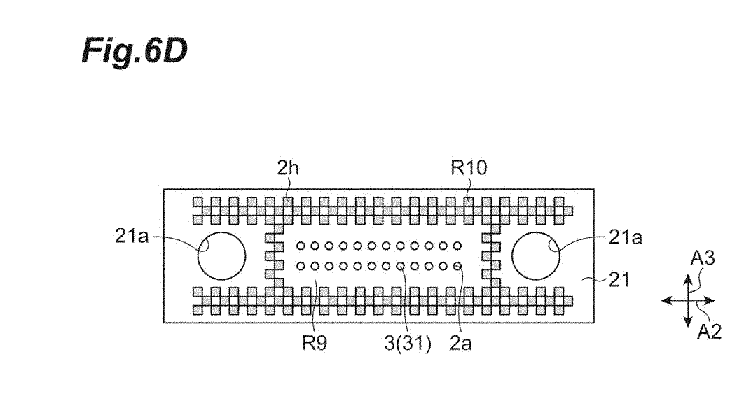

Note that the protrusion portion 2h is formed in a rectangular frame shape surrounding the region R1 in the aforementioned first embodiment, but the shape of the protrusion portion 2h is not limited thereto. For example, as shown in FIG. 6A, the protrusion portion 2h may be formed in a frame-shaped region R4 which surrounds a region R3, where the optical fiber 3 is exposed, and is formed on a further inner side than the pair of guide holes 21a in the direction A2. Moreover, as shown in FIG. 6B, the protrusion portion 2h may be formed in a window-shaped region R6 which surrounds a region R5, where the optical fiber 3 is exposed, and surrounds each of the pair of guide holes 21a. Alternatively, as shown in FIG. 6C, the protrusion portion 2h may be formed in a region R8 which is a region surrounding a region R7, where the optical fiber 3 is exposed, and sandwiches each of the pair of guide holes 21a from the direction A3 as well as extends in the direction A2. Furthermore, as shown in FIG. 6D, the protrusion portion 2h may be formed in a plurality of dot-shaped regions R10 surrounding a region R9 where the optical fiber 3 is exposed.

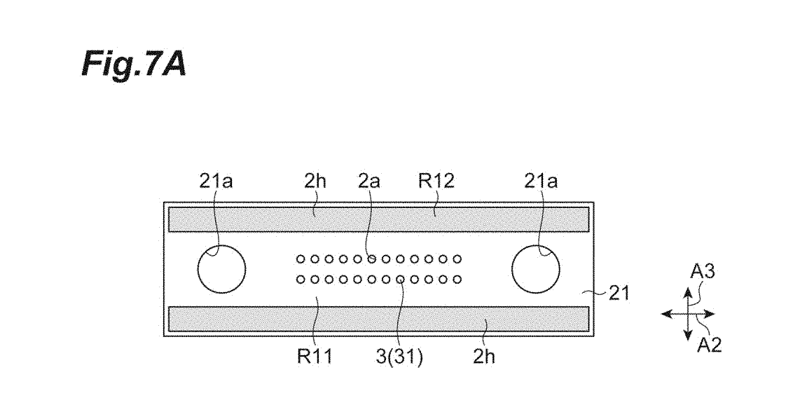

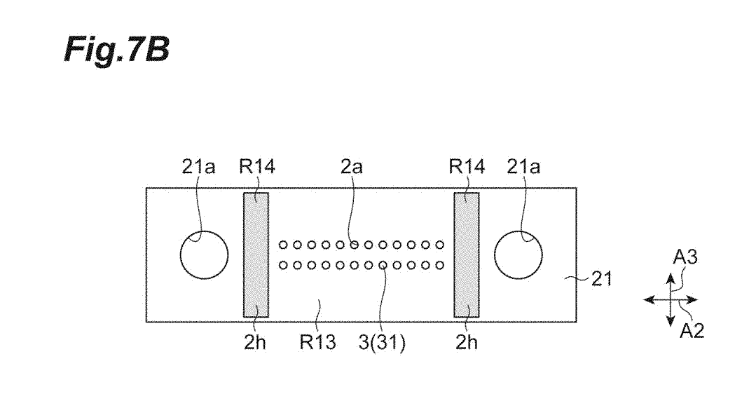

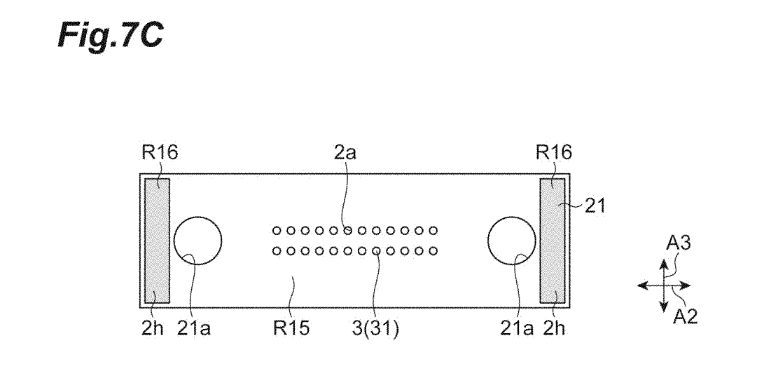

In addition, as shown in FIG. 7A, the protrusion portions 2h may be formed in a pair of upper and lower regions R12 which sandwich a region R11, where the optical fiber 3 is exposed, from the direction A3 and extend in the direction A2. Moreover, as shown in FIG. 7B, the protrusion portions 2h may be formed in a pair of right and left regions R14 which sandwich a region R13, where the optical fiber 3 is exposed, from the direction A2 and extend in the direction A3. Furthermore, as shown in FIG. 7C, the protrusion portions 2h may be formed in regions R16 which sandwich a region R15, which is a region where the optical fiber 3 is exposed and in which the pair of guide holes 21a is formed, from the direction A2 and extend in the direction A3.

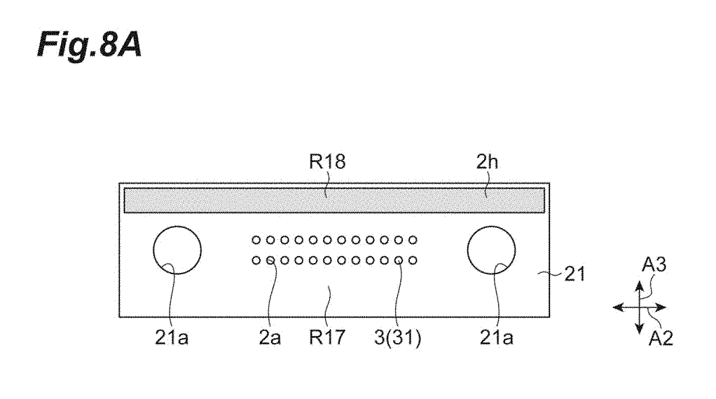

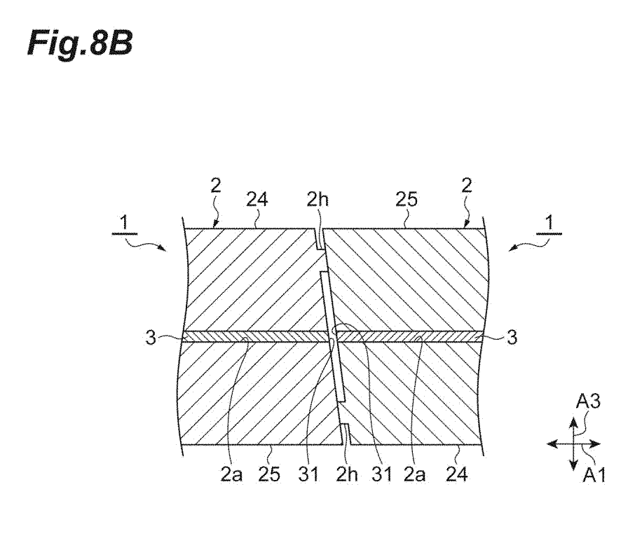

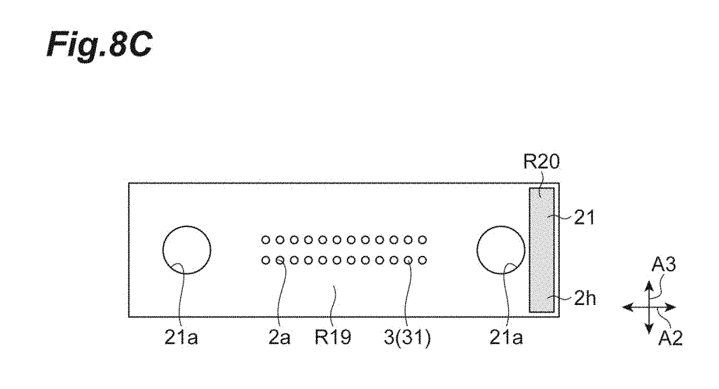

Further, as shown in FIG. 8A, the protrusion portion 2h may be formed in a region R18 which extends on one side of the direction A3 and further in the direction A2 than a region R17 where the optical fiber 3 is exposed. To connect two optical connectors 1 each including this protrusion portion 2h, as shown in FIG. 8B, one optical connector 1 and the other optical connector 1 may be reversed each other to connect the two optical connectors 1 to each other in the connection direction A1. Accordingly, it is possible to adopt a configuration in which the tip faces 31 of the optical fibers 3 do not make contact each other while connection. Note that, as shown in FIG. 8C, the protrusion portion 2h may be formed in a region R20 which extends on one side of the direction A2 and further in the direction A3 than a region R19 where the optical fiber 3 is exposed.

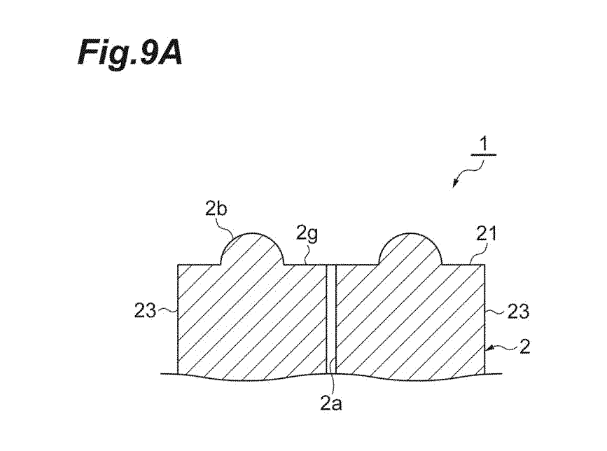

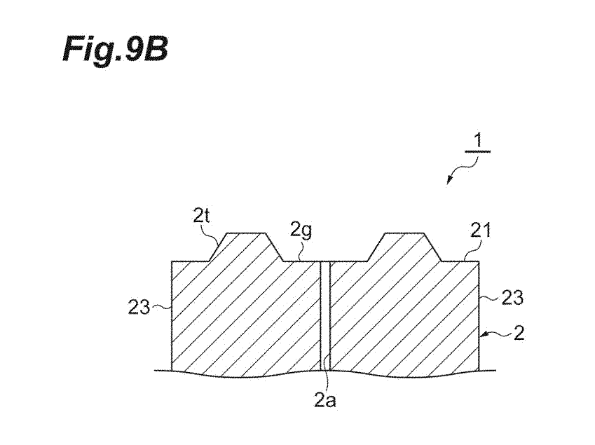

Moreover, the protrusion portion 2h whose protrusion shape from the region R1 is a rectangular shape has been described in the aforementioned first embodiment, but the protrusion shape from the region R1 may be not a rectangular shape. FIGS. 9A and 9B are sectional side views showing modification examples of the protrusion shape of the protrusion portion. A protrusion portion 2b in FIG. 9A protrudes in a hemispherical shape from a recess portion 2g. Furthermore, a protrusion portion 2t in FIG. 9B protrudes in a trapezoidal shape tapering from the recess portion 2g. As described above, the protrusion shape of the protrusion portion can be changed as appropriate.

### Second Embodiment

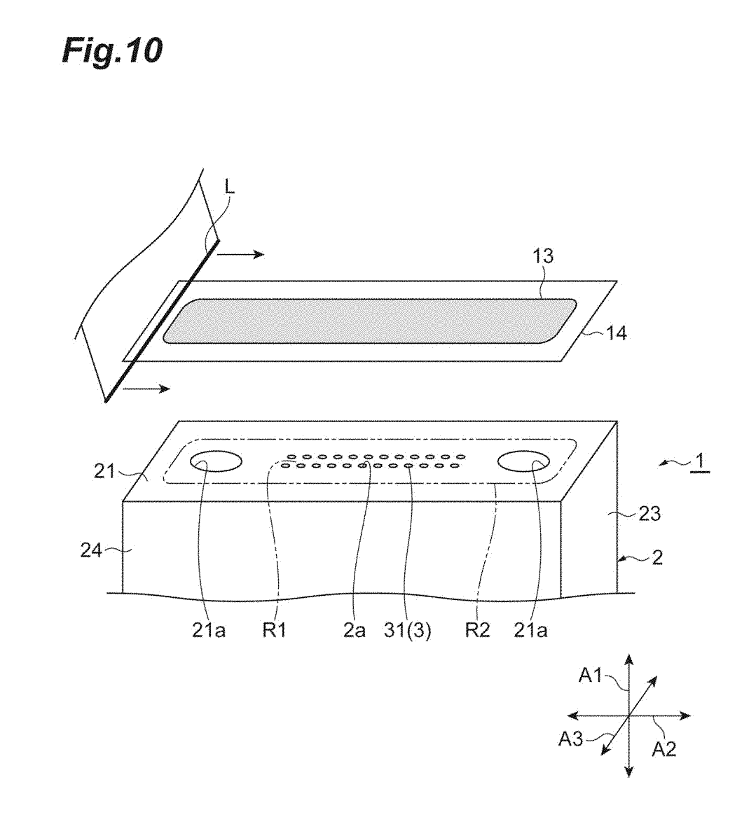

Next, a method for manufacturing an optical connector 1 according to a second embodiment will be described. Hereinafter, the description overlapping with the first embodiment will be omitted. FIG. 10 is a perspective view showing the method for manufacturing the optical connector according to the second embodiment. The second embodiment is different from the first embodiment in that the heating is performed by irradiation with a line beam serving as the laser beam L in the step of making the other region higher.

As in the first embodiment, after an end face 21 is polished together with an optical fiber 3, for example, the end face 21 of a ferrule 2 is directed upward. Then, a mask 13 made of a material which does not transmit a laser beam L is placed on a region R1 at the end face 21. The mask 13 is provided, for example, on a placoid jig 14 which covers the entire end face 21 and transmits the laser beam L.

Then, the end face 21 is irradiated with the laser beam L, which is a linearly extending line beam, through the mask 13 and the placoid jig 14. For example, the laser beam L traverses the end face 21 in a direction A3. A region R2 is heated by scanning this laser beam L in a direction A2. At this time, for example, the laser beam L with high irradiation power is scanned once. Moreover, at the time of the irradiation with the laser beam L, the region R1 is protected by the mask 13. Accordingly, the laser beam L does not reach the region R1, and only the region R2 is irradiated. Therefore, only the region R2 is heated. Then, the region R2 expanded by heating is cooled and cured, thereby forming the protrusion portion 2h. After the protrusion portion 2h is formed, the mask 13 and the placoid jig 14 are detached from the end face 21 to complete the manufacture of the optical connector 1.

As described above, in the method for manufacturing the optical connector 1 according to the second embodiment, the region R2 is irradiated with the line beam serving as the laser beam L to be heated in the step of making the other region R2 higher. By this heating, the region R2 can be made higher than the region R1. Therefore, the effects similar to those of the first embodiment can be obtained. Furthermore, by using the mask 13 to perform the irradiation with the laser beam L, a complicated shape can be easily formed.

### Third Embodiment

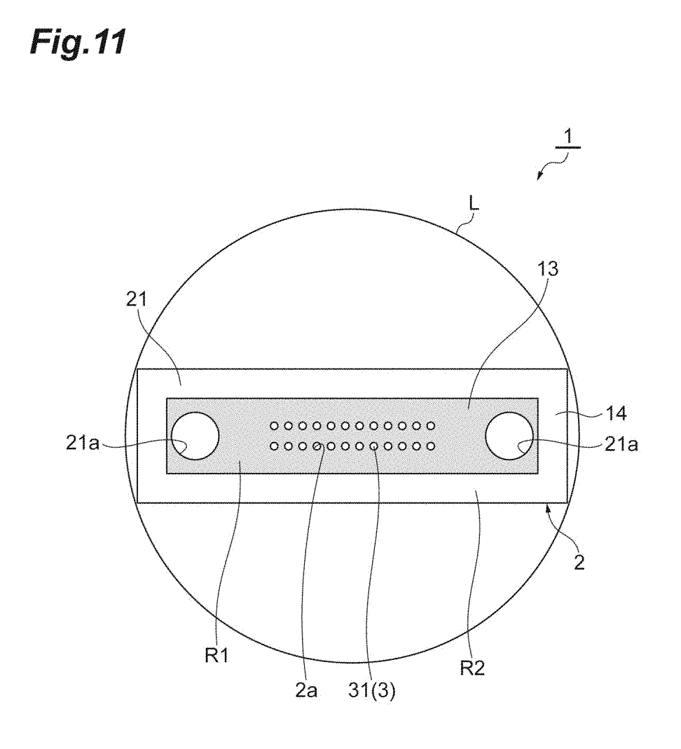

Next, a method for manufacturing an optical connector 1 according to a third embodiment will be described. Hereinafter, the description overlapping with the first and second embodiments will be omitted. FIG. 11 is a plan view showing the method for manufacturing the optical connector according to the third embodiment. The third embodiment is different from the first and second embodiments in that a wide area is irradiated with the laser beam L to heat the region R2 in the step of making the other region higher.

After an end face 21 is polished together with an optical fiber 3 as in each of the aforementioned embodiments, for example, the end face 21 of a ferrule 2 is directed upward, and a mask 13 and a placoid jig 14 are placed on the end face 21 as in the second embodiment. Then, the end face 21 is widely irradiated with a laser beam L with magnitude of a beam diameter covering the entire end face 21 to heat a region R2. At this time, for example, one-time irradiation is performed with the laser beam L with high irradiation power. As in the second embodiment, since the mask 13 is arranged at a place corresponding to the region R1, only the region R2 where the mask 13 is not arranged is irradiated with the laser beam L. Then, the region R2 expanded by heating is cooled and cured, thereby forming the protrusion portion 2h.

As described above, in the method for manufacturing the optical connector 1 according to the third embodiment, the wide area is irradiated with the laser beam L to heat the region R2 in the step of making the other region R2 higher. At this time, as in the second embodiment, only the region R2 can be made higher so that the effects similar to those of each of the aforementioned embodiments can be obtained. That is, as in the second embodiment, a complicated shape can be easily formed.

Although the methods for manufacturing the optical connector 1 according to the embodiments have been described above, the method for manufacturing the optical connector according to the present invention is not limited to each of the aforementioned embodiments, and various modifications are possible.

For example, the examples, in which the region R2 is irradiated with the laser beam L to heat the region R2 in the step of making the other region R2 higher, have been described in the aforementioned embodiments, but the means for heating the region R2 is not limited to these examples. For example, a heating member such as a probe may be brought into contact with the region R2 to heat the region R2.

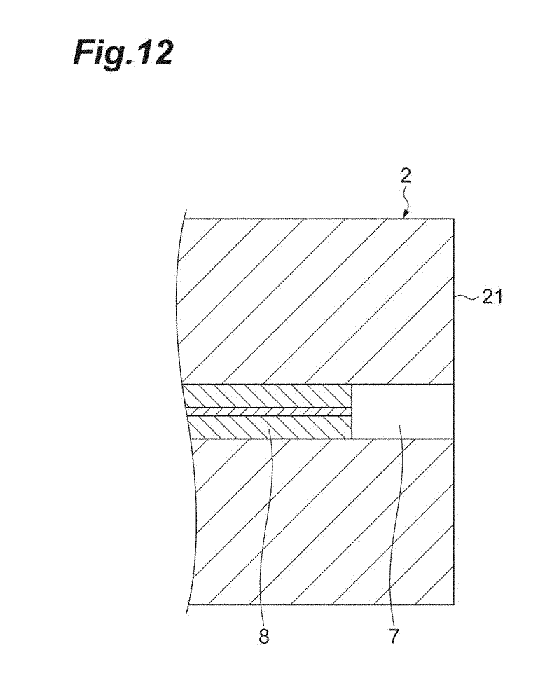

Moreover, the optical connector 1, in which the tip face 31 of the optical fiber 3 is exposed at the end face 21 of the ferrule 2, has been exemplified and described in the aforementioned embodiments, but the structure of the optical connector is not limited to this example. For example, the tip face 31 itself of the optical fiber 3 may be not exposed at the end face 21 of the ferrule 2. FIG. 12 is a view showing a modification example of this optical connector.

As shown in FIG. 12, instead of the tip face 31, a GRIN lens 7, which is a fiber type lens, may be exposed at the end face 21. Note that an optical fiber 8 is arranged on the side of the GRIN lens 7 opposite to the end face 21. Thus, in this specification, the case where the fiber type lens is exposed at the end face of the ferrule is also included in exposing the optical fiber at the end face of the ferrule.

Even when the fiber type lens is exposed at the end face 21 as previously mentioned, the effects similar to those of each embodiment can be obtained by forming the protrusion portion 2h at the end face 21. Furthermore, the type of the optical fibers 3 and 8 may be not a normal single mode fiber, but may be a special single mode fiber, a fiber type lens as described above, or a multimode fiber. A mode field diameter (MFD) enlarged fiber in which an optical fiber with a different MFD is connected to the tip of the optical fiber 3 by fusion, welding or the like, a TEC fiber in which the dopant is diffused by a burner or arc discharge to enlarge the MFD, and the like are also included in the special single mode fiber.

In a case where the special single mode fiber, the fiber type lens, or the multimode fiber is exposed at the end face 21, the upper limit of the height H can be increased. For example, the height H of the protrusion portion 2h can be set to 5 μm or more and 200 μm or less. In this case, the gap between the tip face of the optical fiber and the tip face of the optical fiber of the mating connector can be set to 5 μm or more and 200 μm. Therefore, it is possible to optimize the distance between the two tip faces, and these optical fibers can be connected to each other with low coupling loss. Furthermore, in a case where the special single mode fiber is the aforementioned MFD enlarged fiber, TEC fiber or the like, since the emitted beam diameter is increased, the effect which can reduce the loss due to the axial misalignment between the connectors optically connected to each other can be obtained. Further, since the numerical aperture decreases when the MFD is enlarged, the emitted beam becomes close to collimated light, and the optimum range of the distance between the two tip faces can be widened.

Moreover, the examples, in which the end face 21 of the ferrule 2 and the tip face 31 of the optical fiber 3 are inclined with respect to the plane S, have been described in the aforementioned embodiments. However, the end face of the ferrule and the tip face of the optical fiber may be not inclined with respect to the plane S. In a case where those are not inclined with respect to the plane S, for example, an antireflection coating may be formed at the tip face of the optical fiber. In this case, it is possible to reduce the Fresnel reflection loss generated at the tip face of the optical fiber. The antireflection coating needs to be formed at least at the tip face of the optical fiber, but may be formed at the end face of the ferrule in a case where it is technically difficult to form the coating only at the tip face of the optical fiber. Furthermore, the examples, in which the gap is formed between the two tip faces of the optical fibers by forming the protrusion portion of the height H, such as the protrusion portion 2h or the like, have been described in the aforementioned embodiments. Herein, the protrusion portion 2h of the height H may be not formed at the end face 21 of one optical connector 1, and, for example, protrusion portions of a height H/2, which face each other, may be formed at the respective end faces of the two optical connectors. Further, the examples, in which the optical connector includes the ferrule 2 which is a multi-hole ferrule having the plurality of optical fibers 3, have been described in the aforementioned embodiments, but the optical connector may include a single core ferrule having one optical fiber.

### REFERENCE SIGNS LIST

1 Optical connector
2 Ferrule
2a Optical fiber holding hole
2b, 2h, 2t Protrusion portion
2g Recess portion
3 Optical fiber
4 Guide pin
5 Mating connector
6 Ferrule
7 GRIN lens
8 Optical fiber
10 Laser apparatus
11 Laser head
12 Elastic plate
13 Mask
14 Placoid jig
21 End face
21a Guide hole
22 Rear end face
22a Introduction hole
23 Side face
24 Bottom face
25 Upper face
25a Hole portion
31 Tip face
61 End face
100 Ferrule
120 Optical fiber
102 Hole
104 End face
106 Spacer
121 Tip face
A1 Connection direction
A2, A3 Direction
CL Central axis line
H Height
L Laser beam
R1 to R20 Region
S Plane

1. A method for manufacturing an optical connector having a ferrule including an end face at which an optical fiber holding hole for holding an optical fiber is opened, the method comprising:
a step of inserting the optical fiber into the optical fiber holding hole and fixing the optical fiber to expose the optical fiber at the end face;
a step of polishing the end face together with the optical fiber; and
a step of heating another region excluding a region where the optical fiber is exposed at the end face to make the other region higher than the region where the optical fiber is exposed.

2. The method for manufacturing the optical connector according to claim 1, wherein the other region is irradiated with a laser beam to heat the other region in the step of making the other region higher.

3. The method for manufacturing the optical connector according to claim 1, wherein the other region is heated in the step of making the other region higher so that a height of the other region with respect to the region where the optical fiber is exposed becomes 5 μm or more and 200 μm or less.

4. The method for manufacturing the optical connector according to claim 1, wherein the other region is heated in the step of making the other region higher so that a ratio of an area of the other region to a total area of the end face becomes 5% or more and 60% or less.
